(19) United States
(12) Patent Application Publication
(10) Pub. No.: US 2005/0098581 A1
(43) Pub. Date: May 12, 2005

(54) Foam generation assembly

(76) Inventors: John N. Long, Morton Grove, IL (US); Dave Modrzejewski, Crystal Lake, IL (US); Jim McKinney, Peach Tree City, GA (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/702,902

(22) Filed: Nov. 6, 2003

(51) Int. Cl. B67D 5/58

(52) U.S. Cl. 222/190

(57) ABSTRACT

An improved foam generation assembly for a container includes a foam generator for producing foam. Two channels allow air or liquid into the foam generator. However, if one channel provides air for the foam generator, then the other channel provides liquid. A tube is attached to one channel, and extends near the base of the container. Thus, when the container is in is squeezed while in a generally upright position, liquid enters the tube and passes through a channel into the foam generator. Air enters the foam generator through the other channel. When the container is squeezed in a generally inverted position, air enters the tube and passes through a channel into the foam generator. Liquid enters the foam generator through the other channel. A valve is provided to seal the channels when foam is not being produced by the foam generator. A vent located in the exterior of the foam generation assembly allows air to return to the container.

The present invention relates to handheld dispensers for dispensing foamed liquids.

A foam is a dispersion of gases in a liquid or solid. Many products, such as shaving cream, whipping cream and some cleaning agents, are best dispersed as foam.

Self-contained pressurized dispensing devices have been used extensively with such products. In such a system, a liquid and pressurized gas are placed in the dispensing device. While such dispensing devices have been refined so as to effectively dispense foam, the dispensing devices have several problems. The device requires an exterior shell that is sufficiently strong to adequately contain the pressurized gas. The shell substantially adds to the cost of such a dispensing device. During manufacture, the device must be filled not only with the liquid, but also with the pressurized gas. This also results in an increased cost due to the purchase of the pressurized gas as well as an expense in manufacturing the container. Further, the dispensing device will cease to operate if the pressurized gas is exhausted. Thus, the life of the dispensing device is limited not only by the liquid within in the container, but the pressurized gas as well.

Due to the limitations of self-contained pressurized dispensing devices, foaming devices using flexible or plastic containers with a pump dispenser have been developed. These devices have a flexible container. When the container is squeezed or pumped, liquid and air are forced into a mixing chamber. The liquid foam is then expelled from the container.

While such flexible or pump foaming devises can be effective at producing foam, the devices have several limitations. First, the devices often do not produce foam when first squeezed. Second, the devices often require a large number of moving parts. Such moving parts increase the cost of the device and make it more prone to breakage. Finally, the devices work satisfactorily only in an upright position.

Thus, an improved foam dispensing device overcoming these limitations is highly desirable.

### SUMMARY OF THE INVENTION

An improved foam generation assembly for a flexible container includes a foam generator for producing foam. Two channels allow air or liquid into the foam generator. However, if one channel provides air for the foam generator, then the other channel provides liquid. A tube is attached to one channel, and extends near the base of the container. Thus, when the container is in a generally upright position and is squeezed, liquid enters the tube and passes through a channel into the foam generator. Air enters the foam generator through the other channel.

On the other hand, if the container is inverted and squeezed, air enters the tube and passes through the channel and enters the foam generator, while liquid enters the other channel and enters the foam generator. Thus, the container generates foam in either a generally upright position or a generally inverted position.

To prevent air from bleeding into channels, a valve is positioned over both channels. A valve hold down effectively divides the valve into two flaps, with each flap covering a channel. When the container is squeezed, the flaps fold away from the channels, allowing air and liquid into the foam generator. When the container is released, the flaps are forced by the negative bottle pressure back over the channels, effectively sealing the channels. Thus, air is not introduced into the channel containing the liquid. When inverted, the flap prevents the displacement of air. The flap will also keep liquid out of the air tube, thus producing immediate foam. By keeping the channel which is a conduit for the liquid into the foam generator free of air, the foam generator produces foam almost instantaneously when the container is squeezed.

Air is allowed into the container through a vent located on the exterior of the foam generator. The vent is of a size so that air may enter the container. The vent is also of such a size that the liquid, due to surface tension and its viscosity, is at least somewhat constrained from entering or exiting the vent.

Thus, the foam dispensing device has several advantages over other devices. First, the device works in a generally upright position as well as a generally inverted position as well as positions between the upright and inverted positions, thus creating a very directional device. Second, it produces foam almost instantaneously when squeezed. Finally, the device has few moving parts, and thus is easily and inexpensively manufactured.

These and other objects, advantages and features of the invention will be more readily understood and appreciated by reference to the detailed description of the drawings.

### BRIEF DESCRIPTION OF THE DRAWINGS

FIG. 1 shows a foam dispensing device in an upright position.

FIG. 2 shows a foam dispensing device in an inverted position.

FIG. 3 is a side view of a foam generation assembly with a tube attached.

FIG. 4 is a perspective cutaway view of a foam generation assembly with a tube attached.

FIG. 5 shows a foam generator.

### DETAILED DESCRIPTION OF THE DRAWINGS

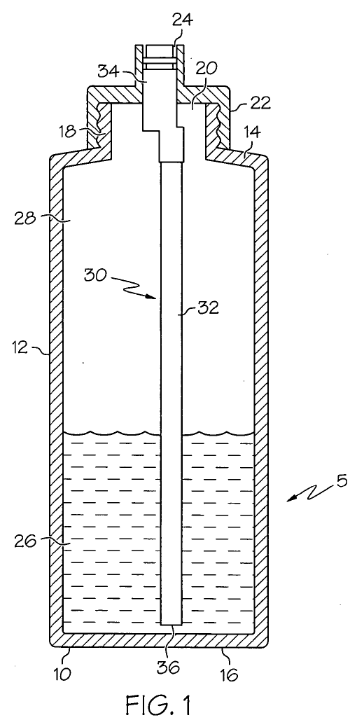

FIG. 1 shows foam dispensing device 5. Foam dispensing device 5 has flexible, handheld container 10. Flexible container 10 is made of a flexible, deformable material, such as plastic.

Flexible container 10 has sidewall 12, top wall 14, and bottom wall 16. Top wall 14 is formed to include neck 18. Neck 18 is shown as threaded, but it could be of any style used in dispensers. Neck 18 has opening 20. Cap 22 is threaded for attachment to neck 18. Passage 24 extends through cap 22. When cap 22 is tightened, the cap is sealed with neck 18. Foam is produced from liquid 26 and air 28 which is held within housing 10.

Foamer 30 is comprised of tube 32 and foam generation assembly 34. Tube 32 is attached to foam generation assembly 34. Tube 32 extends from the foaming engine almost to bottom wall 16. Gap 36 separates tube 32 from bottom wall 16.

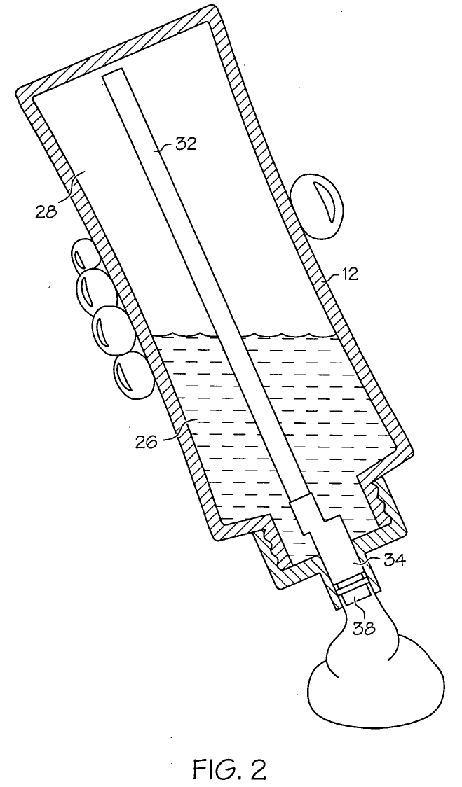

FIG. 2 shows foam dispensing device 5 inverted. Sidewall 12 has been compressed. Air 28 thus enters tube 32 and is mixed with liquid 26 in foam generation assembly 34. Foam is produced within foam generation assembly 34, and is expelled through egress 38.

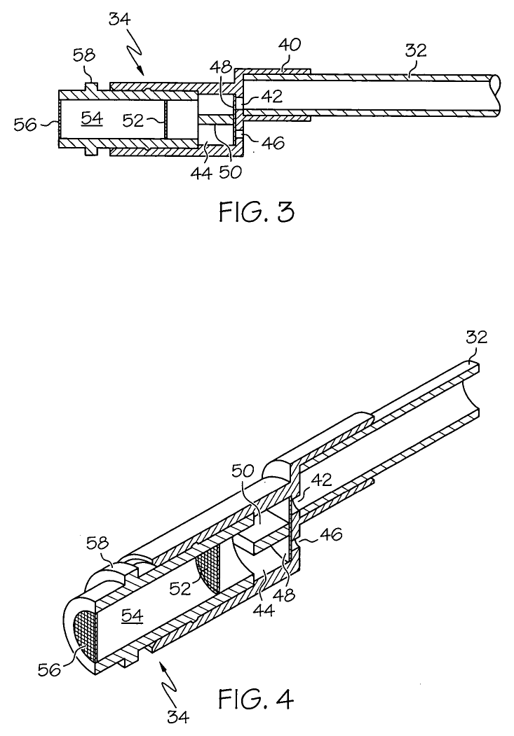

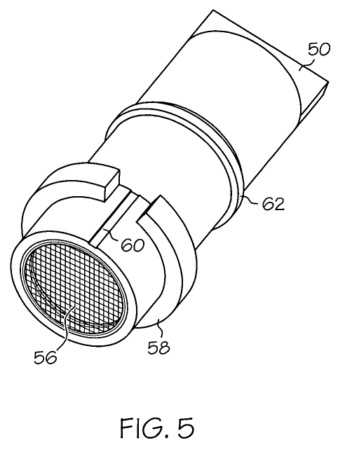

FIG. 3 is a side view of foam generation assembly 34. FIG. 4 is an upper elevation cutaway view of foam generation assembly 34.

Tube 32 extends into collar 40 of foam generation assembly 34. Collar 40 firmly holds tube 32 within foam generation assembly 34. First channel 42 connects the interior of tube 32 to mix chamber 44. Second channel 46 connects the interior of housing 10 with mix chamber 44. First channel 42 has a diameter larger than that of second channel 46. In one embodiment, first channel 42 has a diameter of about 0.050 inch while second channel 46 has a diameter of about 0.025 inch. First channel 42 and second channel 46 are apertures.

Valve 48 covers both first channel 42 and second channel 46. Valve 48 is made of a pliable material which tends to return to its original configuration in the absence of external forces. The thickness of the valve can be from about 0.002 inch to about 0.010 inch. Valve 48 is held over first channel 42 and second channel 46 by valve hold down 50. Valve hold down 50 sits across the middle of valve 48, securing valve 48 to the bottom of mix chamber 44. Valve hold down 50 is of small enough width to allow valve 48 to fold away from first channel 42 and second channel 46. In the absence of any pressure exerted on housing 10, valve 48 is closed.

When valve hold down 50 is in place on valve 48, valve 48 is divided into two flaps. A first flap of valve 48 covers first channel 42. A second flap of valve 48 covers second channel 46.

First mesh 52 and second mesh 56 define a foam chamber 54. First mesh 52 is located at a first end of foam chamber 54. Second mesh is located at a second end of foam chamber 54. Cap stop 58 almost entirely circumvents foam generation assembly 34.

FIG. 5 shows foam generator 49. Foam generator 49 has an interior and an exterior. As shown in FIG. 5, cap stop 58 does not entirely circumvent the exterior of foam generator 49. Vent 60 is provided in the exterior of foam generator 49 and extending through a gap in the cap stop 58. Vent 60 allows air to return to housing 10 after foam is expelled from foam generator 49. While foam generator 49 is shown to have only one vent 60, foam generator 49 could be provided with several vents. Vent 60 is passive. It contains no valve or other movable part.

If a cap is placed on the roamer, cap stop 58 provides a means for locating the foamer in a suitable location in the cap/dispensing device.

First mesh 52 and second mesh 56 are a mesh of suitable material, preferably plastic polymer. The size of the openings in the mesh vary depending upon the characteristics of the particular liquid being foamed as well as the quality of foam desired. Rib 62 extends around foam generator 49. Rib 62 assists in holding foam generator 49 within foam generation assembly 34.

While not wishing to be limited by theory, a description of the operation of the foam dispenser as now understood follows.

When pressure is applied to flexible container 10 while flexible container 10 is in the upright position, liquid travels up tube 32 and opens valve 48. It then travels through first channel 42, and into mix chamber 44. Air enters mix chamber 44 through second channel 46. Since first channel 42 is larger than second channel 46, liquid flows freely out of tube 32 and through first channel 42. Since second channel 46 is smaller than first channel 42, air intake into mix chamber 44 is somewhat restricted.

When the foam dispensing device is inverted and squeezed, then liquid travels through second channel 46, opening valve 48, and then enters mix chamber 44. Air travels down tube 32, through first channel 42 and into mix chamber 44. When inverted, liquid is thus passing through second channel 46 which has a smaller aperture than first channel 42. However, when inverted, the liquid is being drawn through channel 46 by not only the internal pressure of flexible container 10 but also by gravity. By having a smaller opening, excessive amounts of liquid are not allowed to enter mix chamber 44.

Thus, first channel 42 and second channel 46 serve dual purposes depending upon the orientation of the housing 10. Additionally, due to the relative size of first channel 42 and second channel 46, the ratio of air-to-liquid within the mix chamber is maintained within a range so as to provide a similar foam consistency whether in a generally upright position or a generally inverted position.

Whether in a generally upright or a generally inverted position, when pressure is exerted on housing 10, valve 48 folds away from the channels, allowing air and liquid to enter and combine in the mix chamber 44. The air and the liquid then pass through first mesh 52. When the air and liquid go through mesh 52, a coarse foam is created. Foam chamber 54 holds the coarse foam prior to being expelled through second mesh 56. When the coarse foam passes through second mesh 56, the coarse foam becomes more uniform in size and texture. The refined foam is then expelled.

When pressure is no longer exerted on housing 10, housing 10 tends to return to its original shape. The “suck back” of air reentering housing 10 allows valve 48 to close and securely seal both first channel 42 and second channel 46. The valve is pulled back into its original position by the “suck back” as well as by the tendency of valve 48 to return to its original configuration.

Valve 48 is maintained in its closed position after use by a combination of factors. Any liquid in mix chamber 44 or between meshes 52, 56 is trapped. The weight of the trapped liquid on valve 48 assist in maintaining the closure of valve 48. Further, when the pressure on housing 10 is removed, an air pocket is formed within tube 32 between valve 48 and the liquid within housing 10. The pressure of the air pocket is less than the ambient pressure. This difference in pressure between the air pocket in tube 32 and the ambient air pressure causes a biasing force to be applied to valve 48 to maintain its closure over channels 42, 46.

When inverted, valve 48 prevents foam dispensing device 5 from expelling any large quantity of liquid instead of foam. Without valve 48, liquid could move up the dip tube, possibly displacing all the air in the mix chamber, and possibly causing liquid to be emitted rather than foam when housing 10 is initially squeezed.

Air is then returned to the interior of housing 10 by way of vent 60.

Vent 60 is sufficiently small so that there is no significant loss of pressure when housing 10 is squeezed. When foam dispensing device 5 is inverted, vent 60 is sufficiently thin so that surface tension and the viscosity of the liquid prevent the liquid from passing through the vent, even when housing 10 is squeezed. Even though relatively small, vent 60 is sufficiently large to allow air to return to the housing 10 when pressure is removed from housing 10.

Because the valve seals first channel 42 and second channel 46 soon after pressure is removed from housing 10, little air is mixed with the liquid prior to the time the liquid enter mix chamber 44. Thus, the ratio of the air and liquid is controlled, causing the foam produced by the foamer to have a consistent texture.

Foam dispensing device 5 works in the fully upright and fully inverted positions, as well as positions between the fully upright and the fully inverted positions.

The tactile feel by the user of foam dispensing device 5 is similar whether the device is in a generally upright or generally position. That is, the force required to be exerted by a user on foam dispensing device 5 in order to generate foam is approximately the same whether the device is upright or inverted. Thus, a user will be more likely to dispense desired amount of foam, rather than too much or too little. Additionally, foam dispensing device 5 produces foam almost instantaneously when squeezed, with little liquid or air being expelled rather than foam.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A foam generation assembly for a container comprising:
a foam generator for producing foam;
a first channel for allowing either air or liquid into the foam generator; and
a second channel, the second channel capable for allowing either air or liquid into the foam generator, the second channel allowing air into the container if the first channel allows liquid into the foam generator and the second channel allowing liquid into the container if the first channel allows air into the foam generator.

2. The foam generation assembly of claim 1 where the foam generator comprises:
a foam chamber having a first end and a second end;
a first mesh disposed at the first end; and
a second mesh disposed at the second end.

3. The foam generation assembly of claim 2 further comprising:
a valve positioned over the first channel and the second channel.

4. The foam generation assembly of claim 3 where the valve has a first flap capable of covering the first channel and a second flap capable of covering the second channel.

5. The foam generation assembly of claim 4 further comprising:
a valve hold down for securing the valve.

6. The foam generation assembly of claim 5 where the valve hold down is secured to the foam generator and is positioned between the first flap and the second flap.

7. The foam generation assembly of claim 6 where the foam generator has an exterior, and further comprising a vent located in the exterior.

8. The foam generation assembly of claim 7 further comprising a collar substantially circumventing the exterior.

9. A foam dispensing device comprising:
a flexible container for holding a liquid and air, the flexible container having a flexible container opening;
a foam generator placed within the flexible container opening, the foam generator having a foam chamber;
a one-way valve over an entrance to the foam generator; and
a vent allowing air to enter the flexible container.

10. The foam dispensing device of claim 9 where the foam generator includes the vent.

11. The foam dispensing device of claim 10 where the foam generator has an exterior, and the vent is located on the exterior.

12. The foam dispensing device of claim 11 where the foam generator has a first channel and a second channel, the first channel capable of allowing either air or liquid into the foam chamber, and the second channel allowing air into the foam chamber when the first channel allows liquid into the foam chamber and the second channel allows air into the foam chamber when the first channel allows liquid into the foam chamber.

13. The foam dispensing device of claim 12 where the one-way valve comprises a first flap and a second flap, the first flap covering the first channel and the second flap covering the second channel.

14. The foam dispensing device of claim 13 where the foam chamber has a first end and a second end, and a first mesh is disposed at the first end and a second mesh is disposed at the second end.

15. The foam dispensing device of claim 14 where the flexible container has a base, and a tube extends from the foam generator to a position proximal the base.

16. The foam dispensing device of claim 15 where the tube is attached to the first channel.

17. The foam dispensing device of claim 16 further comprising a collar, the collar substantially circumventing the foam generator.

18. The foam dispensing device of claim 17 further comprising a valve hold down.

19. The foam dispensing device of claim 18 where the valve hold down is secured to the foam chamber.

20. A foam generator having an interior and an exterior, the interior having a foam chamber, and the exterior having a vent.

21. The foam generator of claim 20 where the foam chamber has a first mesh and a second mesh.

22. The foam generator of claim 21 where the foam chamber has a first foam chamber end and a second foam chamber end, and the foam generator has a first foam generator end and a second foam generator end, where the first mesh is located near the first foam generator end, and a valve hold down is located near the second foam generator end.

23. The foam generator of claim 22 where the second mesh is positioned near the second foam chamber end.

24. The foam generator of claim 23 where the first foam generator end is located near the first foam chamber end and the second foam generator end is located near the second foam chamber end.

25. The foam generator of claim 24 further comprising a cap stop secured to the exterior.

26. The foam generator of claim 25 further comprising a rib located on the exterior.

27. The foam generator of claim 26 where the exterior has a plurality of vents.

28. The foam generator of claim 10 where the one-way valve prohibits air from entering the flexible container through the foam chamber but allows liquid and air to leave the flexible container through the foam generator.

29. The foam generator of claim 10 where the one-way valve is a pressure actuated valve.

30. The foam generator of claim 29 where the one-way valve opens when pressure is applied to the flexible container.

31. The foam generator of claim 30 where the one-way valve is closed when pressure is not applied to the flexible container.

32. A foam generation assembly for a container comprising:
a foam generator for producing foam;
a first channel, the first channel capable of allowing either air or liquid into the foam generator; and
a second channel, the second channel capable of allowing either air or liquid into the foam generator, the second channel allowing air into the container if the first channel allows liquid into the foam generator and the second channel allowing liquid into the container if the first channel allows air into the foam generator.

33. The foam generation assembly of claim 32 where the first channel is larger than the second channel.

34. The foam generation assembly of claim 33 where the first channel is about twice as large as the second channel.

35. A foam dispenser comprising:
a foam generation assembly located at one end of a container, the container containing air and a liquid, the container having an interior and an interior pressure;
the foam generation assembly having a first aperture in fluidic communication with the air and a second aperture in fluidic communication with the liquid; and
a valve for selectively sealing the first aperture and the second aperture.

36. The foam dispenser of claim 35 where the first aperture is in fluidic communication with the liquid when the container is in a first position and is in fluidic communication with the air when the container is in a second position.

37. The foam dispenser of claim 36 where the second aperture is in fluidic communication with the air when the container is in the first position and is in fluidic communication with the liquid when the container is in the second position.

38. The foam dispenser of claim 37 where the first aperture is larger than the second aperture.

39. The foam dispenser of claim 38 where the first position is a generally upright position.

40. The foam dispenser of claim 39 where the second position is a generally inverted position.

41. The foam dispenser of claim 40 where a tube is attached to the first aperture.

42. The foam dispenser of claim 41 further comprising a vent for returning air to the container when the interior pressure is less than ambient pressure.

43. The foam dispenser of claim 42 further comprising a plurality of vents.

44. The foam dispenser of claim 43 where the first aperture is approximately twice as large as the second aperture.

45. The foam dispenser of claim 44 where the first aperture has a diameter of approximately 0.050 of an inch and the second aperture has a diameter of approximately 0.025 of an inch.
